(19) United States
(12) Patent Application Publication
(10) Pub. No.: US 2019/0364363 A1
(43) Pub. Date: Nov. 28, 2019

(54) EARPHONE

(71) Applicant: Onkyo Corporation, Osaka (JP)

(72) Inventor: Koichi YAZAWA, Osaka (JP)

(21) Appl. No.: 16/404,804

(22) Filed: May 7, 2019

(30) Foreign Application Priority Data
May 28, 2018 (JP) 2018-101406

(51) Int. Cl. H04R 5/033; H04R 1/10

(52) U.S. Cl. CPC H04R 5/033; H04R 1/1016

(57) ABSTRACT

An earphone comprising: a first main body which has a first microphone and a first speaker; a second main body which has a second microphone and a second speaker; and a controller, wherein the controller sets the main body which includes the microphone which collects an audio to the main body for a right ear or the main body for a left ear when any of the microphones collects the audio.

### CROSS-REFERENCE TO RELATED APPLICATIONS

This application claims priority to Japanese Application No. 2018-101406, filed May 28, 2018, the entire contents of which are incorporated herein by reference.

### FIELD

The present invention relates to a stereo type earphone.

### BACKGROUND

A stereo type earphone includes a main body for a right ear which has a speaker and a main body for a left ear which has a speaker. A term of “earphone” includes a headphone such as an over headphone which has a headband and so on and the other earphone such as an inner type earphone and so on. As described above, the stereo type earphone has the main body for the right ear and the main body for the left ear. For this reason, it is necessary that the main body for the right ear and the main body for the left ear are made separately. Further, it is necessary for a user to identify the main body for the right ear and the main body for the left year when the user wears the earphone on its ears.

In JP 2004-274540 A, an invention to be able to confirm whether it is the main body for the right ear or the main body for the left ear is for a user easily is disclosed when the user wears the earphone on its ears.

### SUMMARY OF THE INVENTION

According to one aspect of the disclosure, there is provided an earphone comprising: a first main body which has a first microphone and a first speaker; a second main body which has a second microphone and a second speaker; and a controller, wherein the controller sets the main body which includes the microphone which collects an audio to the main body for a right ear or the main body for a left ear when any of the microphones collects the audio.

### BRIEF DESCRIPTION OF THE DRAWINGS

FIG. 1 is a block diagram illustrating a configuration of an earphone according to a first embodiment of the present invention.

FIG. 2 is a block diagram illustrating a configuration of an earphone according to a second embodiment of the present invention.

### DETAILED DESCRIPTION OF THE PREFERRED EMBODIMENTS

An objective of the present invention is to provide a means that a user can set left and right assignment of an earphone easily.

An embodiment of the present invention is described below.

### First Embodiment

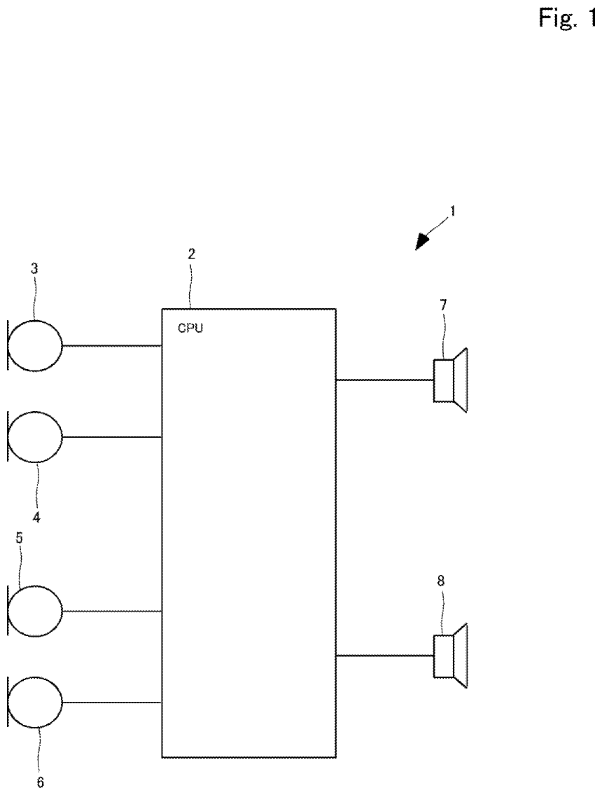

FIG. 1 is a block diagram illustrating a configuration of an earphone according to a first embodiment of the present invention. The earphone 1 is a wired earphone, is connected by USB, for example, and reproduces an audio based on an audio signal which is output from a smart phone. As illustrated in FIG. 1, the earphone 1 includes a CPU 2, microphones 3 to 6, and speakers 7 and 8.

The CPU (Central Processing Unit) 2 (controller) controls each section composing the earphone 1. The earphone 1 includes a noise cancel circuit and performs noise cancel based on an audio which is collected by the microphones 3 to 6. The microphone 3 is a microphone for feedforward. The microphone 4 is a microphone for feedback. The microphone 5 is a microphone for feedforward. The microphone 6 is a microphone for feedback. Each of the speakers 7 and 8 reproduces an audio based on an audio signal.

The microphones 3 and 4 (first microphone) and the speaker 7 (first speaker) are provided at one enclosure and compose a main body (first main body). Further, the microphones 5 and 6 (second microphone) and the speaker 8 (second speaker) are provided at one enclosure and compose a main body (second main body). When the microphones 3 and 4 or the microphones 5 and 6 collects the audio (for example, the audio that any of the main bodies is hit), the CPU 2 sets the main body which includes the microphones 3 and 4 or the microphones 5 and 6 which collect the audio to the main body for the right ear or the main body for the left ear. For example, when a predetermined pattern is collected, the CPU 2 sets the main body which includes the microphones which collect the audio to the main body for the right ear or the main body for the left ear. For example, the predetermined pattern is an audio pattern that the main body is hit three times.

For example, the user wears the main body which includes the microphones 3 and 4 and the speaker 7 on its right ear and wears the main body which includes the microphones 5 and 6 and the speaker 8 on its left ear. The user hits the main body which is worn on its right ear three times. In this case, the CPU 2 sets the main body which has the microphones 3 and 4 to the main body for the right ear because the microphones 3 and 4 collect the predetermined pattern audio. Further, the CPU 2 sets the main body which has the microphones 5 and 6 to the main body for the left ear. In this case, the CPU 2 outputs a right audio signal to the speaker 7 which is included in the main body which is set to the main body for the right ear. The CPU 2 outputs a left audio signal to the speaker 8 which is included in the main body which is set to the main body for the left ear.

Further, for example, the user wears the main body which includes the microphones 5 and 6 and the speaker 8 on its right ear and wears the main body which includes the microphones 3 and 4 and the speaker 7 on its left ear. The user hits the main body which is worn on its right ear three times. In this case, the CPU 2 sets the main body which has the microphones 5 and 6 to the main body for the right ear because the microphones 5 and 6 collect the predetermined pattern audio. Further, the CPU 2 sets the main body which has the microphones 3 and 4 to the main body for the left ear. In this case, the CPU 2 outputs a right audio signal to the speaker 8 which is included in the main body which is set to the main body for the right ear. The CPU 2 outputs a left audio signal to the speaker 7 which is included in the main body which is set to the main body for the left ear. In a case where the CPU 2 outputs the right audio signal to the speaker 7 and outputs the left audio signal to the speaker 8 and in a case where the CPU 2 outputs the right audio signal to the speaker 8 and outputs the left audio signal to the speaker 7, the CPU 2 sets the left and right audio by inverting LRCK.

Herein, a setting application of the earphone 1 is installed in a smart phone or the like to which the earphone 1 is connected. For example, the user wears the main body which has the microphones 3 and 4 and the speaker 7 on its right ear and wears the main body which has the microphones 5 and 6 and the speaker 8 on its left ear. The user activates the setting application which is installed in the smart phone or the like. For example, the setting application displays a message such as “Please hit a right earphone.” and instructs action to make the user hit any of the main bodies of the earphone 1. The user hits the main body which is worn on its right ear. In this case, the CPU 2 sets the main body which has the microphones 3 and 4 to the main body for the right ear because the microphones 3 and 4 collect the audio that the main body is hit. Further, the CPU 2 sets the main body which has the microphones 5 and 6 to the main body for the left ear. In this case, the CPU 2 outputs the right audio signal to the speaker 7 which is included in the main body which is set to the main body for the right ear. The CPU 2 outputs the left audio signal to the speaker 8 which is included in the main body which is set to the main body for the left ear.

Further, for example, the user wears the main body which has the microphones 5 and 6 and the speaker 8 on its right ear and the main body which has the microphones 3 and 4 and the speaker 7 on its left ear. The user activates the setting application which is installed in the smart phone or the like. For example, the setting application displays a message such as “Please hit a right earphone.” and instructs action to make the user hit any of the main bodies of the earphone 1. The user hits the main body which is worn on its right ear. In this case, the CPU 2 sets the main body which has the microphones 5 and 6 to the main body for the right ear because the microphones 5 and 6 collect the audio that the main body is hit. Further, the CPU 2 sets the main body which has the microphones 3 and 4 to the main body for the left ear. In this case, the CPU 2 outputs the right audio signal to the speaker 8 which is included in the main body which is set to the main body for the right ear. The CPU 2 outputs the left audio signal to the speaker 7 which is included in the main body which is set to the main body for the left ear.

In this manner, when the microphones 3 and 4 or the microphones 5 and 6 which are included in the main body (for example, the main body which is worn on the user's right ear) which is instructed by the setting application collect the audio, the CPU 2 sets the main body which includes the microphones which collect the audio to the main body for the right ear or the main body for the left ear.

In the present embodiment, a case where the earphone 1 includes the CPU 2 and the noise cancel circuit, and the CPU 2 performs left and right assign setting of the earphone 1 is described. Not limited to this, a controller (a CPU or the like) which is included in a smart phone or the like to which the earphone 1 is connected may perform left and right assignment setting of the earphone 1 and may a noise cancel circuit which is included in the smart phone or the like may perform noise cancel.

As described above, in the present embodiment, when the microphones 3 and 4 or the microphones 5 and 6 collect the audio, the CPU 2 decides the main body which includes the microphones which collect the audio to the main body for the right ear or the main body for the left ear. For example, the user hits any of the main bodies. The microphones 3 and 4 or the microphones 5 and 6 collect the audio that the main body is hit. The CPU 2 set the main body which includes the microphones which collect the audio, namely, the main body which is hit by the user to the main body for the right ear or the main body for the left ear. In this manner, according to the present embodiment, the user only hits any of the main bodies and can set the main body to the main body for the right ear or the main body for the left ear. For this reason, the user can set left and right assignment of the earphone easily.

Further, in the present embodiment, when the microphones 3 and 4 or the microphones 5 and 6 collect a predetermined pattern, for example, the audio that the main body is hit three times, the CPU 2 sets the main body which includes the microphones 3 and 4 or the microphones 5 and 6 which collect the audio to the main body for the right ear or the main body for the left ear. Thus, the user only hits any of the main bodies several times, and can set the main body to the main body for the right ear or the main body for the left ear. Further, when the predetermined pattern audio is only collected, setting is performed. For this reason, occurring of error setting is prevented.

Further, for example, the application which is for performing setting of the earphone 1 is installed in the smart phone or the like. The application performs display such as “Please hit an earphone which is worn on your right ear.”, and instructs the user to hit the earphone (main body) which is worn. The user hits the earphone which is worn on its right ear. The microphones 3 and 4 or the microphones 5 and 6 collect the audio that the main body is hit. In this case, the CPU 2 sets the main body which is worn the user's right ear to the main body for the right ear because the microphones 3 and 4 or the microphones 5 and 6 which are included in the designated main body which is worn on the user's right ear collect the audio.

Further, in the present embodiment, each of the microphones 3 and 4 and the microphones 5 and 6 is a microphone for noise cancel. For this reason, it is not necessary to provide a microphone newly for left and right assignment of the earphone 1.

### Second Embodiment

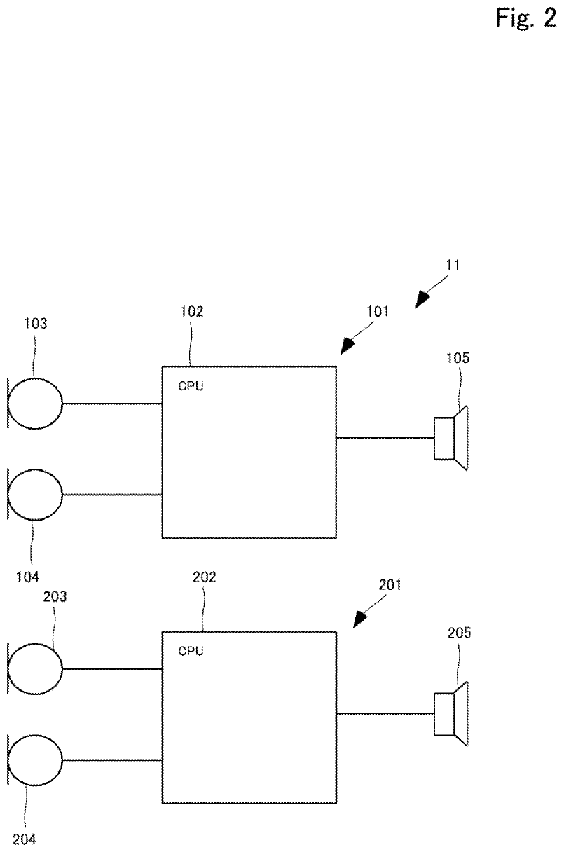

FIG. 2 is a block diagram illustrating a configuration of an earphone according to a second embodiment of the present invention. The earphone 11 is a wireless earphone, is connected to a smart phone by wireless (for example, Bluetooth standard (registered trademark)), for example, and reproduces an audio based on an audio signal which is output from the smart phone. Further, the earphone 11 is a true wireless type ((TWS (True Wireless Stereo)) earphone that two of a main body 101 and a main body 102 which are worn on the user's ears are not connected by wire. As illustrated in FIG. 2, the earphone 11 includes the main body 101 and the main body 102.

The main body 101 (first main body) includes a CPU 102, microphones 103 and 104, and a speaker 105. The CPU 102 (controller) controls each section composing the main body 101. The main body 101 includes a noise cancel circuit and the noise cancel circuit performs noise cancel based on an audio which is collected by the microphones 103 and 104. The microphone 103 (first microphone) is a microphone for feedforward. The microphone 104 (first microphone) is a microphone for feedback. The speaker 105 (first speaker) reproduces the audio based on the audio signal.

The main body 201 (second main body) includes a CPU 202, microphones 203 and 204, and a speaker 205. The CPU 202 (controller) controls each section composing the main body 201. The main body 201 includes a noise cancel circuit and the noise cancel circuit performs noise cancel based on an audio which is collected by the microphones 203 and 204. The microphone 203 (second microphone) is a microphone for feedforward. The microphone 204 (second microphone) is a microphone for feedback. The speaker 205 (second speaker) reproduces the audio based on the audio signal.

When the microphones 103 and 104 or the microphones 203 and 204 collect the audio (for example, the audio that any of the main bodies is hit), the CPUs 102 and 202 set the main body 101 which includes the microphones 103 and 104 or the main body 201 which includes the microphones 203 and 204 to the main body for the right ear or the main body for the left ear. For example, when a predetermined pattern audio is collected, the CPUs 102 and 202 set the main body which includes the microphones which collect the audio to the main body for the right ear or the main body for the left ear. For example, the predetermined is the audio pattern that the main body is hit three times.

For example, the user wears the main body 101 on its right ear and wears the main body 201 on its left ear. The user sets power of the earphone 11 to ON. The user hits the main body 101 which is worn on its right ear three times. In this case, the CPU 102 sets the main body 101 which has the microphones 103 and 104 to the main body for the right ear because the microphones 103 and 104 collect the predetermined pattern audio. Further, the CPU 202 sets the main body 201 which has the microphones 203 and 204 to the main body for the left ear. In this case, the CPU 102 outputs the right audio signal to the speaker 105 which is included in the main body 101 which is set to the main body for the right ear. The CPU 202 outputs the left audio signal to the speaker 205 which is included in the main body 201 which is set to the main body for the left ear.

Further, for example, the user wears the main body 201 on its right ear and wears the main body 101 on its left ear. The user sets power of the earphone 11 to ON. The user hits the main body 201 which is worn on its right ear three times. In this case, the CPU 202 sets the main body 201 which has the microphones 203 and 204 to the main body for the right ear because the microphones 203 and 204 collect the predetermined pattern audio. Further, the CPU 102 sets the main body 101 which has the microphones 103 and 104 to the main body for the left ear. In this case, the CPU 202 outputs the right audio signal to the speaker 205 which is included in the main body 201 which is set to the main body for the right ear. The CPU 102 outputs the left audio signal to the speaker 105 which is included in the main body which is set to the main body for the left ear. In a case where the CPU 102 or the CPU 202 outputs the right audio signal to the speaker 105 and outputs the left audio signal to the speaker 205 and in a case where the CPU 102 or the CPU 202 outputs the right audio signal to the speaker 205 and outputs the left audio signal to the speaker 105, the CPU 102 or the CPU 202 sets the left and right audio by inverting LRCK.

Herein, a setting application of the earphone 11 is installed in a smart phone or the like to which the earphone 11 is connected. For example, the user wears the main body 101 on its right ear and wears the main body 201 on its left ear. The user sets power ON of the earphone 11. The user activates the setting application which is installed in the smart phone or the like. For example, the setting application displays a message such as “Please hit a right earphone.” and instructs action to make the user hit any of the main bodies 101 and 201 of the earphone 11. The user hits the main body 101 which is worn on its right ear. In this case, the CPU 102 sets the main body 101 which has the microphones 103 and 104 to the main body for the right ear because the microphones 103 and 104 collect the audio that the main body 101 is hit. Further, the CPU 202 sets the main body 201 which has the microphones 203 and 204 to the main body for the left ear. In this case, the CPU 102 outputs the right audio signal to the speaker 105 which is included in the main body 101 which is set to the main body for the right ear. The CPU 202 outputs the left audio signal to the speaker 205 which is included in the main body 201 which is set to the main body for the left ear. Further, the CPUs 102 and 202 assign a predetermined function to operation buttons which are included in the main bodies 101 and 201.

Further, for example, the user wears the main body 201 on its right ear and the main body 101 on its left ear. The user sets power ON of the earphone 11. The user activates the setting application which is installed in the smart phone or the like. For example, the setting application displays a message such as “Please hit a right earphone.” and instructs action to make the user hit the main body 101 or 201 of the earphone 11. The user hits the main body 201 which is worn on its right ear. In this case, the CPU 202 sets the main body 201 which has the microphones 203 and 204 to the main body for the right ear because the microphones 203 and 204 collect the audio that the main body 201 is hit. Further, the CPU 102 sets the main body 101 which has the microphones 103 and 104 to the main body for the left ear. In this case, the CPU 202 outputs the right audio signal to the speaker 205 which is included in the main body 201 which is set to the main body for the right ear. The CPU 102 outputs the left audio signal to the speaker 105 which is included in the main body 101 which is set to the main body for the left ear. The CPUs 102 and 202 assign a predetermined function to operation buttons which are included in the main bodies 101 and 201.

The main body 101 further includes a power button (first power button) which is for receiving ON/OFF of power. The main body 201 further includes a power button (second power button) which is for receiving ON/OFF of power. When each of the CPUs 102 and 202 receives power ON of any of the main bodies by the power button, the CPU 102 or the CPU 202 searches for the other main body. Herein, power of the other main body does not become ON, the CPU 102 or 202 judges that the other main body does not exist because the CPU 102 or 202 cannot find out the other main body. When the CPU 102 or the CPU 202 judges that the other main body does not exist, the CPU 102 or the CPU 202 sets the main body that power ON is received to the main body for the right ear or the main body for the left ear.

For example, the user wears the main body 101 on its right ear and wears the main body 201 on its left ear. The user sets power ON of the main body 101 by the power button. The CPU 102 receives power ON of the main body 101 by the power button. The CPU 102 searches for the main body 201. When the CPU 102 judges that the main body 201 does not exist, the CPU 102 sets the main body 101 to the main body for the right ear. The user sets power ON of the main body 201 by the power button. The CPU 202 receives power ON of the main body 201 by the power button. The CPU 202 searches for the main body 101. The CPU 202 judges that the main body 101 exists and sets the main body 201 to the main body for the left ear because power of the main body 101 is ON. A smart phone or the like (source) to which the earphone 11 is connected sets left and right audio output based on left and right which is set by the CPUs 102 and 202. Each of the CPUs 102 and 202 assigns a predetermined function to operation buttons which are included in the main bodies 101 and 201.

As described above, in the present embodiment, when the CPU 102 or the CPU 202 receives power ON of any of the main bodies, the CPU 102 or the CPU 202 searches for the other main body. When the CPU 102 or the CPU 202 judges that the other main body does not exist, the CPU 102 or the CPU 202 sets the main body that power ON is received to the main body for the right ear or the main body for the left ear. Thus, the user only sets power ON of any of the main bodies and can set the main body to the main body for the right ear or the main body to the left ear. For this reason, the user can set left and right assignment of the earphone easily. Further, the microphones 103, 104, 203, and 204 which are for collecting the audio are unnecessary.

The embodiment of the present invention is described above, but the mode to which the present invention is applicable is not limited to the above embodiment and can be suitably varied without departing from the scope of the present invention.

The present invention can be suitably employed in a stereo type earphone.

What is claimed is:

1. An earphone comprising:
a first main body which has a first microphone and a first speaker;
a second main body which has a second microphone and a second speaker; and
a controller,
wherein the controller sets the main body which includes the microphone which collects an audio to the main body for a right ear or the main body for a left ear when any of the microphones collects the audio.

2. The earphone according to claim 1,
wherein the controller sets the main body which includes the microphone which collects the audio to the main body for the right ear or the main body for the left ear when any of the microphones collects the audio that any of the main bodies is hit.

3. The earphone according to claim 1,
wherein the controller sets the main body which includes the microphone which collects the audio to the main body for the right ear or the main body for the left ear when any of the microphones collects a predetermined audio.

4. The earphone according to claim 1,
wherein the controller sets the main body which includes the microphone which collects the audio to the main body for the right ear or the main body for the left ear when the microphone which is included in a designated main body collects the audio.

5. The earphone according to claim 1,
wherein each of the first microphone and the second microphone is a microphone for noise cancel.

6. The earphone according to claim 1,
wherein the controller outputs a right audio signal to a speaker which is included in the main body which is set to the main body for the right ear and outputs a left audio signal to a speaker which is included in the main body which is set to the main body for the left ear.

7. The earphone according to claim 1,
wherein each of the first main body and the second main body further includes a button, and
the controller assigns a predetermined function to a button after the controller sets the main body to the main body for the right ear or the main body for the left ear.

8. An earphone comprising:
a first main body which has a first power button which is for receiving ON/OFF of a power and a first speaker;
a second main body which has a second power button which is for receiving ON/OFF of the power and a second speaker;
and a controller,
wherein the controller searches for the other main body when the controller receives power ON of any of the main bodies by the power button, and
the controller sets the main body that power ON is received to the main body for a right ear or the main body for a left ear when the controller judges that the other main body does not exist.

9. A setting method of an earphone comprising:
a first main body which has a first microphone and a first speaker; and
a second main body which has a second microphone and a second speaker,
wherein the main body which includes the microphone which collects an audio when any of the microphones collects the audio is set to the main body for the right ear or the main body for the left ear.
